(19) United States
(12) Patent Application Publication
(10) Pub. No.: US 2026/0286086 A1
(43) Pub. Date: Sep. 24, 2026

(54) Process for Recycling Polythiourethanes, Thio Compounds, and Use Thereof

(71) Applicants: Bruno Bock GmbH, Marschacht (DE); Friedrich-Schiller Universität Jena, Jena (DE)

(72) Inventors: Catherine Mineur, Tespe (DE); Frank Ebmeyer, Lüneburg (DE); Matthias Rehfeld, Reinbek (DE); Thomas Bätz, Jena (DE); Stefan Zechel, Jena (DE); Martin Hager, Dornburg-Camburg (DE)

(21) Appl. No.: 19/154,558

(22) PCT Filed: Jan. 25, 2024
(86) PCT No.: PCT/EP2024/000005

§ 371 Date: Aug. 7, 2025

(30) Foreign Application Priority Data
Feb. 9, 2023 (DE) 10 2023 000 410.3

(51) Int. Cl. C08J 11/18; C08G 18/38

(52) U.S. Cl. CPC C08J 11/18; C08G 18/3855; C08J 2381/00

(57) ABSTRACT

The invention relates to a process for recycling polythiourethanes.

Disclosed herein is a process wherein polythiourethanes are depolymerized in the presence of di- or higher-functional thiols. Di- and/or higher-functional isocyanates, epoxides or ethylenically unsaturated compounds and optionally di- and/or higher functionalized thiols are subsequently added to the obtained monomer and oligomer mixture. The reaction mixture is then repolymerized. The process allows polythiourethanes to be recycled.

### CLAIM FOR PRIORITY

This application is a national phase application of German Patent Application 10 2023 000 410.3 filed 9 Feb. 2023, and PCT/EP2024/000005 filed 25 Jan. 2024, the priority of which are hereby claimed and their disclosure incorporated by reference herein in their entirety.

### DISCLOSURE

Process for recycling polythiourethanes, thio compounds, and use thereof

### FIELD

The invention relates to a process for the chemical recycling of polythiourethanes as well as to thio compounds formed in the process and their use.

### BACKGROUND OF THE INVENTION

Polythiourethanes are known polymers which can be present in linear or branched form or also as a polymer network. Polythiourethanes are used for a wide variety of applications, e.g. as organic glasses, such as spectacle lenses or optical lenses, as coatings, varnishes, adhesives or potting compounds, as well as foams for use as insulating materials.

As polythiourethanes are often present as a polymer network in the corresponding applications, classic mechanical recycling as known for thermoplastics is ruled out here. Even molded parts or coatings made of linear or branched polythiourethanes are often not easily recyclable, as they contain additives that must be separated before recycling. Polythiourethanes are therefore often not recyclable using conventional methods and the only option is often thermal recycling, i.e. incineration.

So far, only a few initial approaches have been described in the literature that allow polythiourethanes to be recycled. Polythiourethanes are reversible at elevated temperatures of e.g. approx. 120° C. and in the presence of catalysts (e.g. dibutyltin dilaurate, sodium tetraphenylborate with 1-methylimidazole), i.e. the thiourethane bonds show exchange reactions. As the bonds exchange within the polymer network, the network density remains constant and the polymers can therefore be classified as vitrimers. These polymers exhibit, for example, self-healing or shape memory behavior (F. Gamardella, F. Guerrero, S. De la Flor, X. Ramis, A. Serra, “A new class of vitrimers based on aliphatic poly(thiourethane) networks with shape memory and permanent shape reconfiguration”, Eur. Polym. J. 2020, 122, 109361; F. Ganardella, A. Serra, X. Ramis, S. De la Flor, “Actuator behavior of tailored poly(thiourethane) shape memory thermosets”, Polymers 2021, 13, 1571).

These properties were also shown in polythiourethane-urethane networks, which have both thiourethane and urethane bonds. In particular, the reversibility of the former allows recycling (C.-J. Fan, Z.-B. Wen, Z. Y. Xu, Y. Xiao, D. Wu, K.-K. Yang, Y. Z. Wang, “Adaptable strategy to fabricate self-healable and reprocessable poly(thiourethane-urethane) elastomers via reversible thiol-isocyanate click chemistry”, Macromolecules 2020, 53, 4284-4293).

Comparable results were also obtained for thioureas (H. Feng, N. Zheng, W. Peng, C. Ni, H. Song, Q. Zhao, T. Xie, “Upcycling of dynamic thiourea thermoset polymers by intrinsic chemical strengthening”, Nat. Commun. 2022, 13, 397).

The depolymerization of polyurethanes or polythiourethanes and their reaction with di- or polyamines to form oligomeric urea compounds is described in DE 10 2011 008 535 A1.

Crosslinked polythiourethanes were depolymerized with an excess of trithiols in acetonic solution (S. Huang, M. Podgórski, X. Han, C. N. Bowman, “Chemical recycling of poly(thiourethane) thermosets enabled by dynamic thiourethane bonds”, Polym. Chem. 2020, 11, 6879-6883). However, this is a complex process that contradicts the idea of a circular economy and the principles of sustainability. For example, acetone is used as a solvent, which has to be separated at great expense. In addition, wastewater and waste are produced that have to be disposed of; to make matters worse, this wastewater contains large quantities of table salt.

Solvolysis with methanol was also carried out for polythiourethane networks (L. Li, X. Chen, J. M. Torkelson, “Reprocessable polymer networks via thiourethane dynamic chemistry: Recovery of cross-link density after recycling and proof-of-principle solvolysis leading to monomer recovery”, Macromolecules 2019, 52, 8207-8216). The thiol can be laboriously separated from the resulting solution. However, direct repolymerization is not possible here. The conversion is not sustainable, as the problematic solvent dichloromethane is used, and the long reaction times are hardly suitable for commercial use.

Furthermore, a polythiourethane based on a cyclic monomer of carbonyl sulfide (COS) and methylaziridine was prepared (S. Wu, M. Luo, D. J. Darensbourg, D. Zeng, Y. Yao, X. zuo, X. Hu, D. Tan, “Non-isocyanate and catalyst-free synthesis of a recyclable polythiourethane with cyclic structure”, ACS Sustainable Chem. Eng. 2020, 8, 5693-5703). When the polymer is heated, a cyclic monomer can form again. However, no structural variations of the polymer are possible with this method and the aliphatic, linear polythiourethane does not exhibit comparable mechanical properties to crosslinked polymers based on aromatic isocyanates.

### SUMMARY OF THE INVENTION

The invention is based on the objective of creating a process for the chemical recycling of polythiourethanes which enables the direct production of repolymerizable monomers and/or oligomers which can be repolymerized again or used as reactants in other reactions without the need for complicated purification of the resulting monomer/oligomer mixture.

The invention is also based on the objective of creating a process for the chemical recycling of polythiourethanes which is easy to carry out, does not involve any complicated processing steps, follows the principles of sustainability and permits the recycling of polythiourethanes in the sense of a circular economy.

These objectives are solved by the process disclosed herein including preferred embodiments.

The invention relates to a process for recycling polythiourethane comprising the following measures:
a) providing a mixture of polythiourethane and di- or higher-functional thiol and optionally a di- or higher-functional polar protic reactive solvent, wherein at least one mole of di- or higher-functional thiol is used per mole of thiourethane bond of the polythiourethane,
b) depolymerizing the polythiourethane by treating the mixture from step a) at a first reaction temperature, thereby forming di- or higher-functional thiols from the polythiourethane and monomeric and oligomeric thiourethanes terminated with di- or higher-functional thiol,
c) optionally separating impurities from the mixture obtained in step b),
d) adding di- or higher-functional isocyanate or epoxide or ethylenically unsaturated compound and optionally di- or higher-functional thiol to the mixture from step b) or c),
e) treating the mixture from step d) at a second reaction temperature which is lower than, equal to or higher than the first reaction temperature, and sufficient to enable polymerization of the monomeric and oligomeric thiourethanes from step b), the compounds added in step d) and the reactive solvent optionally present occurs, with the proviso that the depolymerization in step b) and the polymerization in step e) occur in substance or in the presence of a di- or higher-functional polar protic reactive solvent.

### BRIEF DESCRIPTION OF THE DRAWINGS

FIG. 1 illustrates a schematic representation of the depolymerization step to form thiol-terminated monomers and oligomers.

### DETAILS OF THE INVENTION

In the process according to the invention, a di- or higher-functional thiol is used in depolymerization step b). The di- or higher-functional thiol formed in the depolymerization step, together with the reactants added in step d) and any reactive solvent present, becomes a component of the repolymerized product, preferably the repolymerized polythiourethane.

The polythiourethanes used according to the invention may be linear, branched or crosslinked types. Preferably, polythiourethane networks are used.

Examples of linear polythiourethanes are polymers with at least 80 mol %, based on the total amount of the polymer, of structural units of the formula (I)

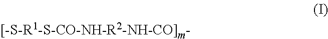

and optionally with up to 20 mol %, based on the total amount of the polymer, of structural units of the formula (IIa) or (IIb)

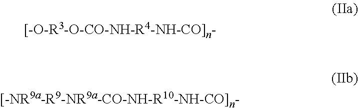

wherein R¹, R², R³, R⁴, R⁹ and R¹⁰ are, independently of one another, divalent organic radicals, in particular alkylene, cycloalkylene, arylene, aralkylene or heterocyclylene,
R^{9a} is hydrogen or a monovalent organic radical, in particular hydrogen, alkyl, cycloalkyl, aryl, aralkyl or heterocyclyl, and most preferably hydrogen or C₁-C₆-alkyl, or the radicals R^{9a} and R⁹ together with the two nitrogen atoms form a piperidinyl radical,
m is an integer of at least 10, preferably from 10 to 100,000 and in particular from 15 to 1,000, and
n is an integer of at least 1, in particular from 1 to 5, with the proviso that R¹, R², R³, R⁴, R⁹, R^{9a} and R¹⁰ may also have different meanings within a molecule within the framework of the given definitions. The term “may also have different meanings within a molecule within the framework of the given definitions” is intended to mean that the single groups and indices can have different meaning, for example, methyl or ethyl or the like, or something different. Alternatively, the term is intended to define that different monomers or indices can appear in one molecule.

Examples of branched polythiourethanes or polymer networks are polymers containing at least 80 mol %, based on the total amount of the polymer, of structural units of the formula (III)

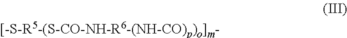

and optionally with up to 20 mol %, based on the total amount of the polymer, of structural units of the formula (IIa) and/or the formula (IIb) and/or the formula (IVa) and/or the formula (IVb)

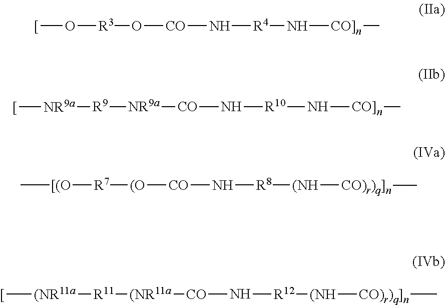

wherein R⁵ is an (o+1)-valent organic radical, in particular an (o+1)-valent alkyl, cycloalkyl, aryl, aralkyl or heterocyclyl radical,
R⁶ is a (p+1)-valent organic radical, in particular a (p+1)-valent alkyl, cycloalkyl, aryl, aralkyl or heterocyclyl radical,
R³, R⁴, R⁹ and R¹⁰ are, independently of one another, divalent organic radicals, in particular alkylene, cycloalkylene, arylene, aralkylene or heterocyclic radicals,
R^{9a} and R^{11a} independently of one another are hydrogen or monovalent organic radicals, in particular hydrogen, alkyl, cycloalkyl, aryl, aralkyl or heterocyclyl, and very preferably hydrogen or C₁-C₆-alkyl, or the radicals R^{9a} and R⁹ together with the two nitrogen atoms form a piperidinyl radical,
R⁷ and R¹¹ independently of one another are (q+1)-valent organic radicals, in particular (q+1)-valent alkyl, cycloalkyl, aryl, aralkyl or heterocyclyl radicals, or the radicals R^{11a} and R¹¹ together with the two nitrogen atoms form a piperidinyl radical,
R⁸ and R¹² are independently (r+1)-valent organic radicals, in particular (r+1)-valent alkyl, cycloalkyl, aryl, aralkyl or heterocyclyl radicals,
m is an integer of at least 10, preferably from 10 to 100,000 and in particular from 15 to 1,000,
n is an integer of at least 1, in particular from 1 to 5,
and p independently of one another denote 1 to 10, preferably 1, 2 or 3, with the proviso that R³, R⁴, R⁵, R⁶, R⁷, R⁸, R⁹, R^{9a}, R¹⁰, R¹¹, R^{11a}, R¹², o, p, q and r can also assume different meanings within a molecule within the framework of the given definitions, in that o and/or p is 2 to 10 at least once per molecule, preferably 2 or 3, in that q and/or r—if present—can also assume different meanings within a molecule within the framework of the given definitions, and in that
q and r independently of one another are 1 to 10, preferably 1, 2 or 3.

The polythiourethanes used according to the invention and the polymers produced by repolymerization can be homopolymers or copolymers.

The difference between branched polythiourethanes and polythiourethane networks is that the former are thermoplastic polymers with more or fewer branching points, whereas polymer networks have polymer chains that are linked together dimensionally. Wide-meshed cross-linking between the main chains leads to elastomers and close-meshed cross-linking between the main chains leads to thermosets.

Polymer networks made of polythiourethanes form a subgroup of thermosets and are characterized by their vitrimeric behaviour. This is a class of plastics that is derived from classic duromers and has strong similarities with them. Vitrimers are made up of covalent networks that can change their topology through thermally activated bond exchange reactions. Vitrimers are strong glass formers. At high temperatures they flow and behave like a viscoelastic liquid. At low temperatures, the exchange reactions are frozen and the vitrimers behave like classic duromers.

If one of the radicals in this description is alkyl, the alkyl group can be either branched or unbranched. An alkyl group typically contains one to twenty carbon atoms, preferably one to ten carbon atoms. Examples of alkyl groups are: methyl, ethyl, n-propyl, isopropyl, n-butyl, sec-butyl, tert. butyl, n-pentyl, n-hexyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or n-eicosyl. Preferred embodiments include alkyl groups with one to six carbon atoms, more preferably one to four carbon atems and most preferred are one to three carbon atoms. Alkyl groups with several carbon atoms may optionally have one or more non-adjacent oxygen atoms and/or one or more non-adjacent carboxylic acid ester residues —CO—O— in the chain. The term alkyl therefore also includes (poly)alkyl ether groups and (poly)alkyl ester groups. Alkyl groups may optionally be substituted, for example with alkoxy, cycloalkyl, aryl, heterocyclyl, halogen, carboxyl ester, carboxyl amide, sulfonic acid ester, sulfonic acid amide or alkyl carbonyl.

If one of the radicals in this description is cycloalkyl, the cycloalkyl group is typically a cyclic group containing three to eight, preferably five, six or seven ring carbon atoms, each of which may be independently substituted. Examples of substituents include alkyl groups or two alkyl groups which, together with the ring carbons to which they are attached, may form a further ring. Examples of cycloalkyl groups are cyclopropyl, cyclopentyl or cyclohexyl. Cycloalkyl groups may optionally be substituted, for example with alkyl, alkoxy, cycloalkyl, aryl, heterocyclyl, halogen, carboxyl ester, carboxylamide, sulfonic acid ester, sulfonic acid amide or alkylcarbonyl.

If one of the radicals in this description is aryl, the aryl group is typically a cyclic aromatic group containing five to fourteen ring carbon atoms, each of which may be independently substituted. Examples of substituents include alkyl groups or two alkyl groups which, together with the ring carbon atoms to which they are attached, may form a further ring. Examples of aryl groups are naphthyl, biphenyl, anthryl or, in particular, phenyl. Aryl groups may optionally be substituted, for example with alkyl, alkoxy, cycloalkyl, aryl, heterocyclyl, halogen, carboxyl ester, carboxyl amide, sulfonic acid ester, sulfonic acid amide or alkyl carbonyl.

If one of the radicals in this description is aralkyl, the aralkyl group is typically an aryl group, where aryl has already been defined above, to which at least one alkyl group is covalently bonded. The aralkyl group can be substituted on the aromatic ring, for example with alkyl groups or with halogen atoms. An example of an aralkyl group is benzyl. Aralkyl groups may optionally be substituted, for example with alkyl, alkoxy, cycloalkyl, aryl, heterocyclyl, halogen, carboxyl ester, carboxyl amide, sulfonic acid ester, sulfonic acid amide or alkyl carbonyl and the like.

If one of the radicals in this description means heterocyclyl, it is typically a cyclic group with three to ten ring carbon atoms and with at least one ring heteroatom, each of which can be substituted independently of one another. Examples of substituents are alkyl groups, or two alkyl groups which, together with the ring carbons to which they are attached, can form a further ring. Examples of heteroatoms are oxygen, nitrogen or sulphur. Examples of heterocyclyl groups are furyl, thienyl, pyrrolyl, imidazolyl, pyridyl, piperidinyl or isocyanurate. Heterocyclyl groups can be aromatic or non-aromatic. Heterocyclyl groups may optionally be substituted, for example with alkyl, alkoxy, cycloalkyl, aryl, halogen, carboxyl ester, carboxyl amide, sulfonic acid ester, sulfonic acid amide or alkyl carbonyl.

If, in this description, one of the radicals means halogen, this is to be understood as a covalently bonded fluorine, chlorine, bromine or iodine atom. Chlorine is preferred.

If one of the radicals in this description is alkylene, the alkylene group can be either branched or unbranched. Alkylene groups correspond to the definition given for alkyl groups with the modification that the group is attached to the remainder of the molecule via two covalent bonds instead of one covalent bond. Alkylene groups with several carbon atoms may have one or more non-adjacent oxygen atoms and/or one or more non-adjacent carboxylic acid ester residues —CO—O— in the chain. The term alkylene thus also includes (poly)alkylene ether groups and (poly)alkylene ester groups. Particularly preferred are alkylene groups with two to twenty, in particular with two to twelve carbon atoms, especially those which have one to three non-adjacent oxygen atoms in the alkylene chain.

If one of the radicals in this description is cycloalkylene, the cycloalkylene group is typically a cyclic group containing three to eight, preferably five, six or seven ring carbon atoms, each of which may be independently substituted. Cycloalkylene groups correspond to the definition given for cycloalkyl groups with the modification that the group is attached to the remainder of the molecule via two covalent bonds instead of one covalent bond. Cyclohexylene is particularly preferred.

If one of the radicals in this description is arylene, the arylene group is typically a cyclic aromatic group containing five to fourteen ring carbon atoms, each of which may be independently substituted. Arylene groups correspond to the definition given for aryl groups with the modification that the group is attached to the remainder of the molecule via two covalent bonds instead of one covalent bond. Phenylene is particularly preferred.

If one of the radicals in this description is aralkylene, the aralkylene group is typically an arylene group, where arylene has already been defined above, to which at least one alkylene group is covalently bonded. Aralkylene groups correspond to the definition given for aralkyl groups with the modification that the group is attached to the remainder of the molecule via two covalent bonds instead of one covalent bond. Benzylene is particularly preferred.

If one of the radicals in this description means heterocyclene, the heterocyclic group is typically a cyclic group with three to ten ring carbon atoms and with at least one ring heteroatom, each of which can be substituted independently of one another.

Heterocyclene groups correspond to the definition given for heterocyclyl groups with the modification that the group is attached to the remainder of the molecule via two covalent bonds instead of one covalent bond. Isocyanurate is particularly preferred.

Trivalent or higher alkyl, cycloalkyl, aryl, aralkyl or heterocyclyl radicals correspond to the definitions given above for alkyl, cycloalkyl, aryl, aralkyl or heterocyclyl with the modification that these groups are attached to the remainder of the molecule via three or more covalent bonds instead of one covalent bond.

The polythiourethanes used according to the invention can be prepared using conventional polymerization processes. Examples of this are polymerization in substance, polymerization in solution or emulsion or suspension polymerization. These methods are known to the skilled person.

The polythiourethanes used according to the invention can be prepared, for example, by polymerization of diisocyanates of the formula (V) and/or of higher-functional isocyanates of the formula (VI) with dithiols of the formula (VII) and/or with higher-functional thiols of the formula (VIII)

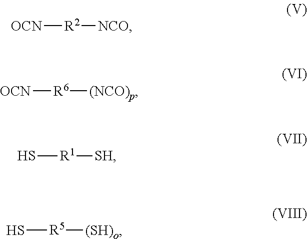

wherein R¹, R², R⁵, R⁶, o and p have the meaning defined above.

Optionally the reaction mixture may contain a total of up to 20 mol %, based on the total amount of polyisocyanates of formulae (V) and (VI), of further polyisocyanates of formulae (IX), (X), (XI) and/or (XII)

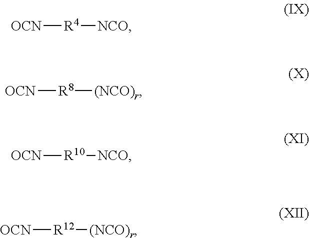

wherein R⁴, R⁸, R¹⁰, R¹² and r have the meaning defined above.

Optionally the reaction mixture may contain a total of up to 20 mol %, based on the total amount, of thiols of formulae (VII) and (VIII), of polyhydroxy compounds or of polyamine compounds of formulae (XIII), (XIV), (XV) and/or (XVI)

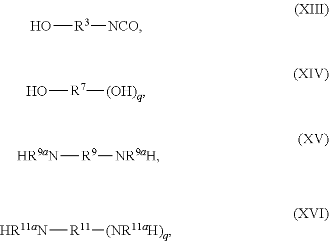

wherein R³, R⁷, R⁹, R^{9a}, R¹¹, R^{11a} and q have the meaning defined above.

Instead of or in addition to the di- or higher-functional isocyanates, it is also possible to use blocked multifunctional isocyanates which can be converted into isocyanates by heating. Blocking agents in particular include alcohols, phenols, amines, oximes, amides, imides, imidazoles, pyrazoles and triazoles.

The monomers required to produce the polythiourethanes used according to the invention are known and are commercially available or can be synthesized using standard organic chemistry processes. These may be monomers which have been produced by petrochemical and/or bio-based processes.

The chain length, degree of branching and crosslinking density of the polythiourethanes used according to the invention can be adjusted by selecting the type and quantity of monomers. The methods for this are known to the skilled person.

The polythiourethanes used according to the invention may contain additives which are typically used together with such polymers. Examples of these are processing aids or additives which impart certain properties to the polymers. Examples include dyes, pigments, heat stabilizers, glass or carbon fibres, fillers, antioxidants, UV stabilizers, antistatic agents, lubricants, biocides, preservatives or blowing agents.

The process according to the invention comprises carrying out a depolymerization. For this purpose, polythiourethane is combined with di- and/or higher-functional thiol (step b). The depolymerization can take place in the presence or in the absence of a di- and/or higher-functional polar protic reactive solvent.

Preferably, depolymerization is carried out in the absence of a solvent.

The polythiourethane can be present in substance, in solution, in suspension or as a paste and can be used in any form. Preferably, work is carried out in substance and, in particular, comminuted polythiourethane is used, for example as a powder or in the form of pellets.

Solvents that can be used in the process according to the invention are di- or higher-functional protic polar compounds that are liquid at room temperature (25° C.).

Di- or higher-functional protic polar reactive solvents include di- or higher-functional aliphatic alcohols with at least two hydroxyl groups, such as ethylene glycol, propylene glycol or tetramethylene glycol or polyethylene glycol, polypropylene glycol or polytetramethylene glycol with at least two alkylene glycol repeating units or primary and secondary di-, tri- or tetraamines, such as ethylenediamine, propylenediamine or butylenediamine or diaminopolyethylene glycol, diaminopolypropylene glycol or copolymers thereof with at least two alkylene glycol repeating units.

The di- or higher-functional thiol used in step b) is a compound of formula (XVII)

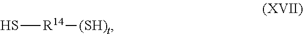

wherein R¹⁴ is a (t+1)-valent organic radical, in particular a (t+1)-valent alkyl, cycloalkyl, aryl, aralkyl or heterocyclyl radical, and
t is an integer greater than or equal to 1, preferably from 1 to 9 and in particular from 1 to 3.

Mixtures of di- and higher-functional thiols or of different difunctional thiols or of higher-functional thiols can also be used.

The thiols used can be based on petrochemical or bio-based raw materials that contain functionalities suitable for thiofunctionalization. These suitable functionalities are, for example, unsaturated carbon-carbon bonds, epoxy groups or halogens. These functionalities can also be introduced into the starting compound by one or more intermediate steps.

The thiol is used in an equimolar amount or preferably in molar excess. The amount of thiol is selected in such a way that a mixture of polythiourethane and thiol is present in which at least one mole of thiol is present per mole of thiourethane bond of the polythiourethane. Preferably, 1 to 100 moles, in particular 1.5 to 50 moles, of thiol are used per mole of thiourethane bond of the polythiourethane. Alternatively, the thiol is present in at least one mole per mole thiourethane, or 1.5 mole thiol is present in at least one mole per mole thiourethane, or 10 mole thiol is present in at least one mole per mole thiourethane, and less than 100 mole thiol is present in at least one mole per mole thiourethane, or less than 50 mole thiol is present in at least one mole per mole thiourethane, or less than 30 mole thiol is present in at least one mole per mole thiourethane.

The depolymerization can be carried out at temperatures between 2° and 220° C. Preferred reaction temperatures are in the range from 30 to 210° C., in particular in the range from 50 to 200° C. Alternatively, the temperatures are greater than 20° C., or greater than 30° C., or greater than 50° C. or greater than 100° C., while the temperatuare is also less than 220° C. or less than 210° C. or less than 180° C.

The duration of the depolymerization reaction can cover wide ranges. Typically, the depolymerization reaction may last from 5 minutes to 60 hours, preferably from 10 minutes to 30 hours and in particular from 10 minutes to 20 hours.

A catalyst may be used for the depolymerization. These may be catalysts that are also used for the production of the polythiourethanes. Examples are basic catalysts, such as tertiary amines, e.g. diisopropylethylamine, or 1,8-diazabicyclo[5.4.0]undec-7-ene (DBU), phosphines, such as triphenylphosphine, or heavy metal compounds, in particular organic tin compounds, such as dibutyltin dilaurate.

If a catalyst is used, the proportion of catalysts in the reaction mixture is typically 0.01 to 10 mol %, based on the amount of thiol, preferably 0.1 to 3 mol %.

Depolymerization is preferably carried out in substance, i.e. in the absence of solvents or dispersants.

Preferably, the reaction mixture consists only of polythiourethane, thiol and optionally catalyst.

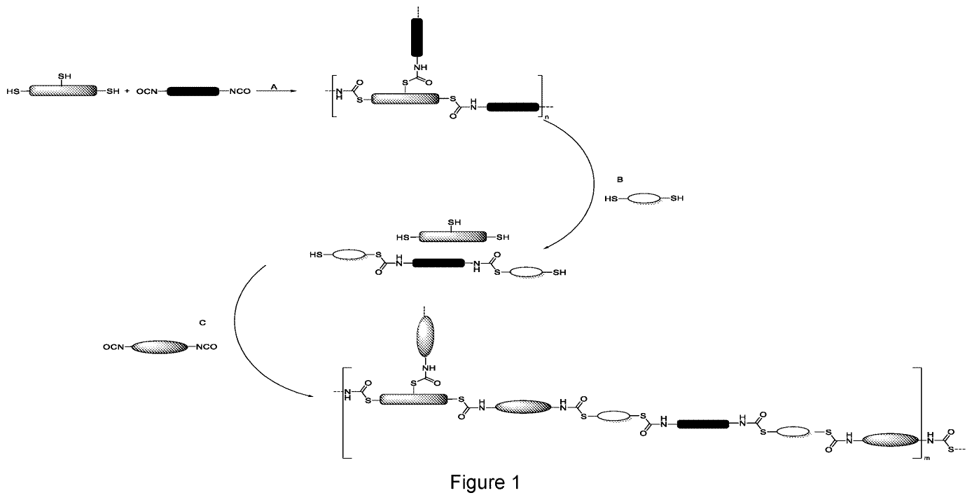

In the depolymerization stage, the polythiourethane is cleaved and oligomeric and monomeric compounds are formed, which are converted to thiol-terminated monomers and thiol-terminated thiourethane oligomers by reaction with the thiol. This is shown schematically in FIG. 1. The composition of the reaction mixture at the end of the depolymerization stage and thus the length of the individual cleavage pieces or the number of thiourethane repeating units in the resulting oligomers is determined by the molar ratio of thiol to the starting compound.

In addition to monomeric di- or higher-functional thiourethanes, oligothiourethanes capped with thiol are also present. These are usually oligomers with 2 to 16, preferably 2 to 8 and in particular 2 to 6 thiourethane units in the molecule. Typically, more than 50%, in particular more than 80%, of all oligomers have degrees of oligomerization of 2 to 16.

The initial reaction mixture (step a) is usually a mixture of solids or of solids and liquids or a solution or dispersion of reactants in a solvent. As a result of the depolymerization, a monomer and oligomer mixture is formed, which may still contain solid components from the initial mixture. At the end of the depolymerization, a stirrable mixture is present in any case. This is preferably liquid.

During depolymerization, monomers and oligomers, i.e. thiourethane monomers and thiourethane oligomers, are produced from the starting polythiourethanes by cleavage in step b).

The monomers and oligomers have mercapto groups of the formula (XVIII), which are linked to the remainder of the molecule via thioisocyanate groups

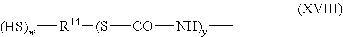

wherein w is an integer greater than or equal to 1, preferably from 1 to 9 and in particular from 1 to 3,
R¹⁴ and t have the meanings defined above,
w is less than t, and
y is an integer with the value t+1−w.

These mercapto groups can also assume different meanings within a molecule within the framework of the given definitions.

Optionally the oligomers can have further free mercapto groups of the formula-SH, which are linked to the molecule via the radical R⁵.

The monomers are compounds of the formulae (XIX) or (XX), which are derived from a polyisocyanate

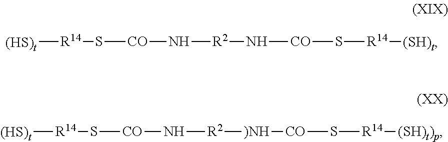

wherein R², R⁶, R¹⁴ and t have the meaning defined above, and
p is 2 to 10, preferably 2 or 3.

The oligomers are compounds of the formula (XXI) or compounds containing structural units of the formula (XXII) which are derived from at least two polyisocyanates

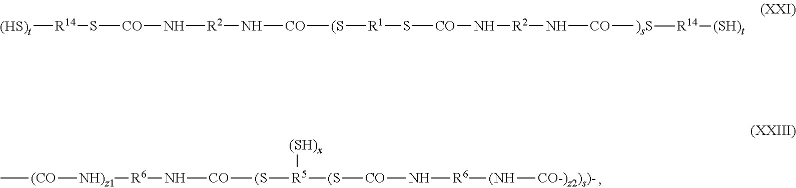

wherein R¹, R², R¹⁴R¹, R², R¹⁴ and t have the meaning defined above,
R⁵ is an (x+z2+1)-valent organic radical, in particular an (x+z2+1)-valent alkyl, cycloalkyl, aryl, aralkyl radical or heterocyclyl radical,
R⁶ is a (z1+1)-valent or a (z2+1)-valent organic radical, in particular a (z1+1)-valent alkyl, cycloalkyl, aryl, aralkyl radical or heterocyclyl radical,
s is an integer from 1 to 15, preferably from 1 to 12,
x is an integer from 0 to 9,
z1 and z2 are integers from 1 to 10,
the sum x+z2 is an integer from 1 to 10.
with the proviso that R¹, R², R⁵, R⁶, R¹⁴, t, x, z1 and z2 can also assume different meanings within a molecule within the framework of the given definitions, and that the oligomer of the formula (XXII) has further groups of the formula (XVIII) which are linked to the oligomer via thioisocyanate groups.

The oligomers with the structural units of the formula (XXII) preferably contain at least 25 mol %, in particular at least 50 mol % and more so in particular 80 mol %, based on the total amount of the oligomer, of these structural units.

The oligomers containing the structural units of the formula (XXII) can optionally contain 0% up to 20 mol %, preferably about 0%-15 mol %, and more preferably about 3-12 mol %, with most preferred about 5-10 mol %, based on the oligomer, of structural units of the above-mentioned formulae (IVa) or (IVb).

In addition to the residues of formula (XVIII), the oligomers may also contain amino end groups derived from the isocyanates. These end groups have the structure of formula (XXIII)

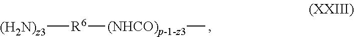

wherein R⁶ and p have the meanings defined above, and
z3 is an integer from 1 to 10.

The proportion of these amino end groups is up to 30 mol %, preferably up to 10 mol % and in particular 0 mol %, based on the total amount of end groups in the molecule.

In the following, some species formed by the depolymerization from the mixture of monomeric and oligomeric cleavage pieces are described by way of example.

The mixture contains monomers of the formulae (XIX) or (XX) given above. In addition, the mixture contains dimers, trimers and their analogous higher oligomers.

An example of possible dimers are compounds of the formula (XXIV), (XXVa) or (XXVb)

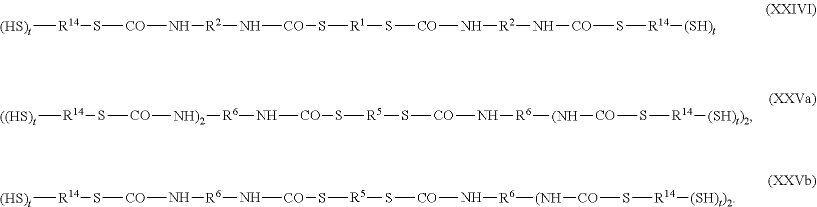

Further examples of monomers, dimers and trimers derived from trifunctional isocyanates and difunctional mercaptans are listed below.

Difunctional mercaptans are characterized by

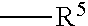

Trifunctional isocyanates are characterized by.

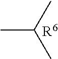

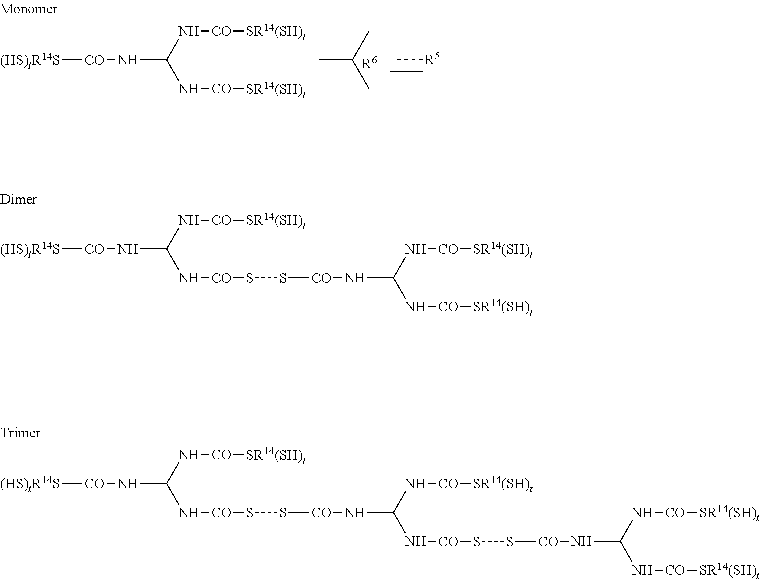

The compositions of monomeric and oligomeric cleavage pieces are novel and are also the subject of the present invention.

The proportion of monomeric cleavage pieces of formula (XIX) or (XX) in the composition may be from 0 to 100 mol %, based on the total amount of cleavage pieces in the composition.

The proportion of oligomeric cleavage pieces of formula (XXI) or (XXII) in the composition may also be 0 to 100 mol %, preferably about 20-70 mol % and most preferably about 30-50 mol %, based on the total amount of cleavage pieces in the composition.

The proportion of monomers and oligomers in the composition can be controlled by the amount of thiol used in step b).

It is also an object of the invention to use these compositions for the preparation of polythiourethanes, for the preparation of copolymers containing polythiourethane groups or as curing agents for epoxides or for compounds containing ethylenically unsaturated groups.

referred embodiments are compositions of monomeric and oligomeric cleavage pieces, with the proviso that monomers and thiourethane oligomers obtained by depolymerization of a polythiourethane network derived from 4,4-methylene bis-(cyclohexyl isocyanate) and ethoxylated trimethylolpropane tris-(3-mercaptopropionate) are excluded.

Particularly preferred embodiments are compositions of monomeric and oligomeric cleavage pieces in which R¹ and R² independently of one another are alkylene, cycloalkylene, arylene, aralkylene or heterocyclylene, R⁵ is an (x+z2+1)-valent alkyl, cycloalkyl, aryl, aralkyl or heterocyclyl radical, R⁶ is a (z1+1)-valent alkyl, cycloalkyl, aryl, aralkyl or heterocyclyl radical, R¹⁴ is a (t+1)-valent alkyl, cycloalkyl, aryl, aralkyl or heterocyclyl radical, x+z2 is 1, 2 or 3, and t is an integer from 1 to 9 and in particular from 1 to 3.

Equally preferred embodiments are compositions of monomeric and oligomeric cleavage pieces, wherein R¹ is cycloalkylene, arylene, aralkylene or heterocyclylene, in particular arylene, and R⁵ is an (x+z2+1)-valent cycloalkyl, aryl, aralkyl or heterocyclyl radical, in particular an (x+z2+1)-valent aryl radical.

Also preferred embodiments are compositions of monomeric and oligomeric cleavage pieces which do not contain any structural units of the formula (IIa), (IIb), (IVa) and/or (IVb).

After depolymerization, the resulting oligomer mixture can be freed from undesirable additives (step c). This can be done, for example, by filtration or distillation or by other separation operations known to the person skilled in the art.

The oligomer mixture thus produced can be repolymerized to a polymer, e.g. to a polythiourethane, immediately after its production or after an interruption at any later time. Alternatively, the oligomer mixture containing free mercaptan groups can also be used as a reactant in other reactions. Examples of this are polycondensation with dicarboxylic acids or use as a curing agent for epoxy compounds or compounds containing ethylenically unsaturated groups.

In the process according to the invention, di- and/or higher-functional isocyanate, di- and/or higher-functional epoxide, di- and/or higher-functional compound containing ethylenically unsaturated groups and optionally di- and/or higher-functional thiol (step d) are added to the monomer/oligomer mixture.

Mixtures of di- and higher-functional isocyanates or of different difunctional isocyanates or of higher-functional isocyanates can also be used. The same applies to the di- or higher-functional epoxides and to the di- or higher-functional compounds containing ethylenically unsaturated groups.

In addition, mixtures of isocyanates, epoxides and/or compounds containing ethylenically unsaturated groups can also be used.

The proportion of the di- and/or higher-functional isocyanate, epoxide or compound containing ethylenically unsaturated groups added in step d) is typically selected such that for every 1 mol of mercapto groups in the monomer/oligomer mixture from step b2) 0, 01 to 500 mol, in particular 0.2 to 100 mol of isocyanate-epoxide or ethylenically unsaturated groups from the added isocyanate(s), epoxide(s) or compound(s) containing ethylenically unsaturated groups.

For the repolymerization in step e) the same catalysts can be used as for the depolymerization in step b).

If a catalyst is used, the proportion of catalysts in the reaction mixture in step e) is typically 0.01 to 10 mol %, based on the amount of thiol, preferably 0.1 to 3 mol %.

The repolymerization in step e) can be carried out at temperatures between 2° and 220° C. Preferred reaction temperatures are in the range of 30 and 210° C., in particular in the range of 50 and 200° C.

The duration of the repolymerization reaction in step e) may cover wide ranges. Typically, the repolymerization reaction can last from 5 minutes to 60 hours, preferably from 10 minutes to 30 hours and in particular from 10 minutes to 20 hours.

Preferred polymerization reaction times include greater than 10 minutes, greater than 60 minutes, greater than 5 hours, and greater than 10 hours. Preferred reaction times are less than 20 hours, less than 15 hours, and less than 11 hours.

The pressure in the repolymerization reaction in step e) may comprise wide ranges. Work can be carried out at negative pressure, atmospheric pressure and positive pressure. Preferably, work is carried out at atmospheric pressure.

The repolymerization in step e) is preferably carried out in substance, i.e. bulk polymerization conducted in the absence of solvents or dispersants.

As a rule, the reaction mixture in the repolymerization stage in step e) consists only of monomer and oligomer mixture from the depolymerization, the added di- and/or higher-functional isocyanate, epoxide and/or compound containing ethylenically unsaturated groups and optionally catalyst and/or optionally di- or higher-functional polar protic reactive solvent.

Alternatively, di- and/or higher-functional thiol can additionally be added to the monomer and oligomer mixture from the depolymerization prior to the repolymerization in step d), which together with the monomers and oligomers from step b) and the di- and/or higher-functional isocyanate, epoxide and/or compound containing ethylenically unsaturated groups from step d) forms a repolymer.

The proportion of the di- and/or higher-functional thiol added in step d) is typically selected such that the total proportion of mercapto groups in the reaction mixture corresponds approximately to the total proportion of isocyanate, epoxide and/or ethylenically unsaturated groups in the reaction mixture. There are typically 0.5 to 1.5 mol, in particular 0.8 to 1.2 mol of isocyanate, epoxide and/or ethylenically unsaturated groups in the reaction mixture per 1 mol of mercapto groups in the reaction mixture.

In this variant, the reaction mixture in the repolymerization stage in step e) consists only of monomer and oligomer mixture from the depolymerization, added thiols and isocyanate(s), epoxide(s) and/or compound(s) containing ethylenically unsaturated groups and optionally catalyst.

Preferably, a higher temperature is selected in the repolymerization stage in step e) than in the depolymerization stage.

After completion of the repolymerization in step e), the reaction mixture is cooled and the catalyst, if present, is inactivated by general procedures known to those of skill in the art.

The resulting repolymer can then be subjected to a shaping process. Alternatively, the resulting repolymer can be comminuted, for example formed into pellets or ground into powder, before being subjected to further processing.

The reactions can be carried out in conventional stirred reactors, dispersers, high-speed mixers, jet dispersers, reaction extruders, extruders or mixer-kneaders utilizing procedures known to those of skill in the art.

The depolymerization can be carried out separately from the repolymerization and is preferably carried out in different reactors.

The process according to the invention can be carried out in a batchwise or continuous manner. Preference is given to batch processes.

Suitable di- or higher-functional isocyanates are all aliphatic, cycloaliphatic, araliphatic or aromatic isocyanates known per se, aromatic di- or polyisocyanates being preferred.

The following isocyanates are preferably used to produce the polythiourethanes used according to the invention or for repolymerization:

Phenyl diisocyanates, phenyl triisocyanates, toluene diisocyanates, toluene triisocyanates, diphenylmethane diisocyanates, diphenyl ether diisocyanates, alkylene diisocyanates, such as tetra-, penta-, hexa- and octamethylene diisocyanate, alkylene triisocyanates, such as tetra-, penta-, hexa- or octamethylene triisocyanate and their trimers, xylylene di- or triisocyanates, mono-, di, tri- or tetramethylxylylene di- or triisocyanates, dicyclohexylmethane diisocyanates, dicyclohexyl ether diisocyanates, cyclohexyl di- or triisocyanates, mono-, di-, tri- or tetraalkylcyclohexyl diisocyanates, such as isophorone diisocyanate, norbornane diisocyanate, triphenylmethane triisocyanates, biphenyl diisocyanates, isocyanurate-tris-N-alkylene isocyanates or naphthalene di- or triisocyanates. Mixtures of two or more of these compounds can also be used, and the isocyanates used can originate from petrochemical or bio-based processes.

Alternate embodiments to the above-mentioned di- or higher-functional isocyanates, comprise their blocked variants which can also be used. Examples of these are isocyanates which have been blocked with alcohols, phenols, amines, oximes, amides, imides, imidazoles, pyrazoles and triazoles and can be converted into isocyanates by heating using procedures known to those of skill in the art.

The following isocyanates are particularly preferred for the production of the polythiourethanes used according to the invention or for repolymerization:

4,4′-Diphenylmethane diisocyanate, 1,4-phenylene diisocyanate, 1,4-xylylene diisocyanate, toluene-2,4-diisocyanate, toluene-2,6-diisocyanate, 2,4′-diphenylmethane diisocyanate, 2,2′-diphenylmethane diisocyanate, hexane-1,6-diisocyanate and its trimers, isophorone diisocyanate, norbornane diisocyanate, tetramethylxylylene diisocyanate, 4,4′-dicyclohexylmethane diisocyanate, triisocyanatononane and cyclohexane-1,4-diisocyanate, and the like.

Embodiments include the following epoxides which are preferably used for repolymerization in step e):

Polyglycidyl esters, polyglycidyl ethers and cycloaliphatic epoxides, preferably those having on average more than one epoxide group directly bonded to an atom or atoms of oxygen or nitrogen. As examples of such epoxides, polyglycidyl and poly(beta-methylglycidyl) esters, obtainable by reaction of a compound having two or more carboxylic acid groups per molecule with epichlorohydrin, glycerol dichlorohydrin or beta-methyl epichlorohydrin in the presence of alkali. Such polyglycidyl esters can be derived from aliphatic polycarboxylic acids, for example from oxalic acid, succinic acid, glutaric acid, adipic acid, pimelic acid, cork acid, azelaic acid, sebacic acid or dimerized or trimerized linoleic acid; of cycloaliphatic polycarboxylic acids, such as tetrahydrophthalic acid, 4-methyltetrahydrophthalic acid, hexahydrophthalic acid and 4-methylhexahydrophthalic acid; and of aromatic polycarboxylic acids, such as phthalic acid, isophthalic acid and terephthalic acid.

Further embodiments or examples comprise polyglycidyl and poly(beta-methylglycidyl) ethers, obtainable by reacting a compound containing at least two free alcohol hydroxyl and/or phenol hydroxyl groups per molecule with the appropriate epichlorohydrin under alkaline conditions or alternatively in the presence of an acidic catalyst and subsequent treatment with alkali. These ethers can be obtained from acyclic alcohols, such as ethylene glycol, diethylene glycol and higher poly(oxyethylene) glycols, propane-1,2-diol and poly(oxypropylene) glycols, propane-1,3-diol, butane-1,4-diol, poly(oxy-tetramethylene) glycols, pentane-1,5-diol, hexane-1,6-diol, hexane-2,4,6-triol, glycerol, 1,1,1-trimethylolpropane, pentaerythritol, sorbitol and polyepichloro-hydrins; from cycloaliphatic alcohols, such as resorcitol, quinitol, bis(4-hydroxycyclohexyl)-methane, 2,2-bis(4-hydroxycyclohexyl)propane and 1,1-bis(hydroxymethyl)cyclohex-3-ene; and from alcohols with aromatic nuclei, such as 2,4-(dihydroxymethyl)-benzene. They can also be prepared from mononuclear phenols, such as resorcinol and hydroquinone, and from polynuclear phenols, such as bis(4-hydroxyphenyl)-methane, 4,4′dihydroxydiphenyl, 1,1,2, 2-tetrakis(4-hydroxy-phenyl)ethane, 2,2,-bis(4-hydroxyphenyl)propane, 2,2-bis(3,5-dibromo-4-hydroxy-phenyl)propane and novolaks formed from aldehydes such as formaldehyde, acetaldehyde, chloral and furfurol, with phenols, such as phenol itself and phenol substituted in the ring with chlorine atoms or alkyl groups, each containing up to nine carbon atoms, such as 4-chlorophenol, 2-methylphenol and 4-tert-butylphenol.

Additional embodiments of epoxides in which some or all of the epoxide groups are not terminal include, vinylcyclohexene dioxide, limonene dioxide, dicyclopentadiene dioxide, 4-oxatetracyclo[6.2.1.02,7.03,5]undec-9-ylglycidyl ether, the bis(4-oxatetracyclo(6.2.1.02,7.03,5]undec-9-ylether of ethylene glycol, 3,4-epoxycyclohexylmethyl-3′,4′epoxycyclohexane carboxylate and its 6,61-dimethyl derivative, the bis(3,4-epoxycyclohexane carboxylate) of ethylene glycol, 3-(3,4-epoxycyclohexyl)-8,9-epoxy-2,4-dioxaspiro[5,5]undecane and epoxidized butadienes or copolymers of butadiene with ethylenic compounds, such as styrene and vinyl acetate, and the like.

Still further embodiments include epoxy resins with 1,2-epoxide groups bonded to various types of heteroatoms can be used, for example glycidyl ether glycidyl esters of salicylic acid, and the like. A mixture of epoxy resins can also be used.

The following epoxides are particularly preferred for repolymerization in step e):

Polyglycidyl esters, polyglycidyl ether of 2,2-bis(4-hydroxyphenyl)propane, of bis(4-hydroxyphenyl)methane or of a novolak formed from formaldehyde and phenol, or phenol substituted in the ring with a chlorine atom or with an alkyl hydrocarbon group containing one to nine carbon atoms and with a 1,2-epoxide content of at least 0.5 equivalents per kilogram and 3,4-epoxycyclohexylmethyl 3′,4′epoxycyclohexane-carboxylate.

Preferred embodiments include the following compounds containing ethylenically unsaturated groups which are used for repolymerization in step e):

Allyl compounds, vinyl compounds, ethylenically unsaturated carboxylic acids or derivatives thereof, such as esters or amides thereof.

Allyl compounds include organic compounds with at least one allyl group, preferably with two or more allyl groups. These include, in particular, esters of unsaturated carboxylic acids with allyl alcohol, N-allyl compounds, polyallyl ethers, polyallylamines or allyl esters of phosphoric acid, and the like. A mixture of allyl compounds can also be used.

The following embodiments of allyl compounds are particularly preferred for repolymerization in step e):

Allyl (meth)acrylate, maleic acid diallyl ester, triallyl cyanurate, pentaerythritol tri- and tetraallyl ether, polyethylene glycol diallyl ether, monoethylene glycol diallyl ether, glycerol di- and triallyl ether, polyallyl ether based on sorbitol, as well as ethoxylated variants thereof, tetraallyloxyethane, triallylamine or tetraallylethylenediamine, and the like.

Vinyl compounds include organic compounds with at least one, preferably two or more vinyl groups. These include, in particular, vinyl ethers or vinyl esters of aliphatic monocarboxylic acids, especially acetic acid. A mixture of vinyl compounds can also be used.

The ethylenically unsaturated carboxylic acids and their derivatives include organic compounds with at least one preferably with two or more ethylenically unsaturated groups and with one or more carboxyl groups, or their esters or amides.

These include in particular mono- or di-ethylenically unsaturated mono- or dicarboxylic acids or their esters or amides, for example esters of ethylenically unsaturated carboxylic acids with mono- or polyfunctional alcohols or amides of ethylenically unsaturated carboxylic acids with mono- or polyfunctional amides and the like. A mixture of ethylenically unsaturated carboxylic acids and their derivatives can also be used.

The following derivatives of ethylenically unsaturated carboxylic acids are particularly preferred for repolymerization in step e):

Acrylates and methacrylates of monohydric alcohols, such as alkyl esters of acrylic acid or methacrylic acid, in particular methyl acrylate, ethyl acrylate, propyl acrylate, butyl acrylate, pentyl acrylate, hexyl acrylate, 2-ethylhexyl acrylate, methyl methacrylate, ethyl methacrylate, propyl methacrylate, butyl methacrylate, pentyl methacrylate, hexyl methacrylate and 2-ethylhexyl methacrylate and the like.

Acrylates and methacrylates of polyhydric alcohols, such as ethylene glycol diacrylate, triethylene glycol diacrylate, dipropylene glycol diacrylate, tripropylene glycol diacrylate, butanediol 1,4-diacrylate, pentamethylene glycol diacrylate, neopentyl glycol diacrylate, hexamethylene glycol diacrylate, 1,1,1-trimethylol-propane triacrylate, pentaerythritol tetraacrylate and corresponding methacrylates and the like. Other suitable polyfunctional materials are reaction products of hydroxyalkyl acrylates or methacrylates with isocyanate group-terminated prepolymers derived from polyols and polyisocyanates and the like.

Acrylamides and methacrylamides of mono- or polyvalent amines, such as N-methylacrylamide and N-methylmethacrylamide. N,N′-methylene bisacrylamide and N,N′-methylene bismethacrylamide.

Further preferred compounds containing ethylenically unsaturated groups are esters of epoxy resins with carboxylic acids containing a polymerizable (meth)acrylic group. Such acids include acrylic acid, methacrylic acid, dimers of acrylic acid and methacrylic acid and adducts of hydroxyalkyl acrylates or methacrylates, such as 2-hydroxyethyl methacrylate or 2-hydroxypropyl acrylate with polycarboxylic acid anhydrides and the like.

The following di- or higher-functional thiols are preferably used for the production or depolymerization of the polythiourethanes used according to the invention or for repolymerization:

Phenyl dithiols, phenyl trithiols, toluene dithiols, toluene trithiols, diphenylmethane dithiols, diphenyl ether dithiols, alkylene dithiols, such as di-, tri-, tetra-, penta-, hexa-, hepta-, octa-, nona-, deca-, undeca- and dodecamethylene dithiols, alkylene tri- and tetrathiols such as terpene thiols, myrcentrithiol, farnesene tetrathiol, alkylene ether dithiols, xylylene dithiols, mono-, di-, tri- or tetramethylxylylene dithiols, dicyclohexylmethane dithiols, dicyclohexyl ether dithiols, cyclohexyl dithiols, mono-, di-, tri- or tetraalkylcyclohexyl dithiols, triphenylmethane trithiols, biphenyl dithiols, isocyanurate-tris-N-alkylene thiols, naphthalene dithiols, naphthalene trithiols, di-, tri- or tetraesters of mercaptoalkanoic acids with di-, tri- or tetrahydric alcohols, in particular di-, tri- or tetraesters of 3-mercaptopropionic acid or thioglycolic acid with di-, tri- or tetrahydric aliphatic alcohols, such as ethylene glycol, diethylene glycol ether, trimethylolpropane, its ethoxylated or propoxylated derivatives, penthaerythritol and polycaprolactone and the like. Mixtures of two or more of these compounds can also be used.

The following embodiments of di- or higher-functional thiols are particularly preferred for the production or depolymerization of the polythiourethanes used according to the invention or for repolymerization:

Hexanedithiol, dodecanedithiol, limonene dithiol, myrcentrithiol, fern tetrathiol, pentaerythritol tetra-(3-mercaptopropionate), trimethylolpropane tri-(3-mercapto-propionate), tris-[2-(3-mercaptopropionyloxy)ethyl]isocyanurate, ethylene glycol di-(3-mercaptopropionate), diethylene glycol ether di-(3-mercaptopropionate), dipentaerythritol hexa-(3-mercaptopropionate), ethoxylated trimethylolpropane tri-(3-mercaptopropionate), propoxylated trimethylolpropane tri-(3-mercaptopropionate) and polycaprolactone tetra-(3-mercaptopropionate) and the like.

If reactive solvents are used in addition to di- or higher-functional thiols, these are typically aliphatic or aromatic di- or polyhydroxy compounds. Preferably, diols, triols or tetrols or mixtures thereof are used. Polyether alcohols are preferred as polyhydroxy compounds.

In preferred embodiments of the process according to the invention, the depolymerization in step b) and the repolymerization in step e) are carried out via bulk polymerization, or polymerization in substance.

In further preferred embodiments of the process according to the invention, the depolymerization in step b) and the repolymerization in step e) are carried out in the presence of a catalyst.

This catalyst is preferably selected from the group consisting of tertiary amine, 1,8-diazabicyclo[5.4.0]undec-7-ene (DBU), phosphine or organic tin compounds.

In further preferred embodiments of the process according to the invention, the first reaction temperature and the second reaction temperature are in the range from 30° C. to 210° C., preferably from 50 to 200° C.

In additional preferred embodiments of the process according to the invention, 1.5 to 50 moles of the di- or higher-functional thiol are used in step a) per mole of thiourethane bond of the polythiourethane.

In further preferred embodiments of the process according to the invention, oligomeric polythiourethanes having two to sixteen repeat units are produced in the depolymerization step.

In a particularly preferred embodiment of the process according to the invention, di-, tri- or tetrafunctional thiols are used in step a), which are preferably selected from the group consisting of hexanedithiol, dodecanedithiol, pentaerythritol tetra-(3-mercapto-propionate), trimethylolpropane tri-(3-mercapto-propionate), tris-[2-(3-mercapto-propionyl-oxy)-ethyl]-isocyanurate, ethylene glycol di-(3-mercaptopropionate), diethylene glycol ether di-(3-mercaptopropionate), dipentaerythritol hexa-(3-mercaptopropionate), ethoxylated trimethylolpropane-tri-(3-mercapto-propionate), propoxylated trimethylolpropane-tri-(3-mercaptopropionate), polycaprolactone tetra-(3-mercaptopropionate) or mixtures of two or more thereof.

In a particularly preferred embodiment of the process according to the invention, di- or higher-functional isocyanates are used in steps d) and e), which are selected in particular from the group consisting of 4,4′-diphenylmethane diisocyanate, 1,4-phenylene diisocyanate, 1,4-xylylene diisocyanate, toluene-2,4-diisocyanate, toluene-2,6-diisocyanate, 2, 4′-diphenylmethane diisocyanate, 2,2′-diphenylmethane diisocyanate, hexane-1,6-diisocyanate, and its trimer isophorone diisocyanate, norbornane diisocyanate, pentamethylene diisocyanate and its trimer, tetramethylxylylene diisocyanate, 4,4′-dicyclohexylmethane diisocyanate, triisocyanatononane, cyclohexane-1,4-diisocyanate or mixtures of two or more thereof.

Particularly preferred embodiments of the process according to the invention are those in which polythiourethane networks are used in step a).

Further particularly preferred embodiments of the process according to the invention are those in which the thiol obtained from the polythiourethane in step b) is a tri- or higher-functional, preferably a trifunctional thiol.

Also preferred are processes in which a polythiourethane is used in step a) which is a polythiourethane network composed of biobased monomers.

Further preferred are processes in which the di- or higher-functional thiol used in step a) is a biobased raw material and/or in which the di- or higher-functional isocyanate or epoxide or ethylenically unsaturated compound used in step d) are biobased raw materials.

The polythiourethanes obtained by repolymerization according to the invention can be used, like their starting products, in a wide variety of fields of technology. The polythiourethanes can be formed into molded parts of any shape. Examples of this are fibres, films or moulded articles, obtainable from the polythiourethane produced by repolymerization according to the invention by any desired moulding process, for example by injection moulding, compression moulding, foam injection moulding, internal gas pressure injection moulding, blow moulding, film casting, calendering, laminating or coating of any desired substrates.

FIG. 1 illustrates an example of the process according to the invention.

FIG. 1 shows a step A preceding the process according to the invention. This is a synthesis of polythiourethane networks (from multifunctional thiols; shown here as an example for trithiols, and multifunctional isocyanates; shown here as an example for diisocyanates). The recycling of these polythiourethanes is shown in steps B and C. The polythiourethane networks are depolymerized into the monomers or into a mixture of oligomers with the aid of a difunctional thiol (step B). After the addition of a mutlifunctional isocyanate, here for example a diisocyanate, the mixture is repolymerized again to form a polymer network (step C).

The depolymerization with bifunctional thiol and the subsequent repolymerization shown in FIG. 1 can be carried out as follows, for example: The polythiourethane networks are depolymerized here for recycling with the aid of a difunctional thiol (e.g. hexanedithiol, dodecanedithiol, ethylene glycol bis(3-mercaptopropionate)). More highly functionalized thiols can also be used. Depolymerization is preferably carried out in substance. The thiol is only used in slight excess. The reaction temperature here is between 2° and 220° C., ideally between 5° and 200° C. A catalyst can be used for the reaction, for example DBU or DBU with triphenylphosphine or organic tin compounds. For repolymerization, the monomer/oligomer mixture is heated after adding another of the multifunctional isocyanates, e.g. a diisocyanate such as pentamethylene diisocyanate, hexamethylene diisocyanate, toluene diisocyanate or methylene di(phenyl isocyanate). This again creates a polythiourethane network.

### EXAMPLES

The following examples illustrate the process according to the invention without limiting it

### Synthesis of a Polythiourethane: Synthesis of poly(pentaerythritol tetrakis(2-mercaptoacetate)-co-hexamethylene diisocyanate)

44 g Pentaerythritol tetrakis(2-mercaptoacetate) (0.102 mol) was mixed with 34.3 g hexamethylene diisocyanate (0.204 mol) and then left to stand for 3 days at room temperature. The colorless solid was crushed using a laboratory mill (IKA A10 basic).

DSC: Tg=63° C.

### Elemental Analysis:

| | | | | |
|---|---|---|---|---|
| calculated [%]: | C: 45.30 | H: 5.77 | N: 7.29 | S: 16.68 |
| found[%]: | C: 45.49 | H: 5.94 | N: 7.56 | S: 16.35 |

### Example 1: Degradation with ethylene glycol bis(2-mercaptoacetate) and Repolymerization

537 mg of polythiourethane network (pentaerythritol-tetrakis(2-mercaptoacetate)-co-hexamethylene diisocyanate; ratio 1/2; 0.70 mmol (calculated on pentaerythritol-tetrakis(2-mercaptoacetate) repeating unit)) was mixed with ethylene glycol bis(2-mercaptoacetate) (881 mg; 4.19 mmol) in a microwave vial. The vial was sealed airtight and the mixture was stirred at 150° C. for 3.5 hours.

To 425 mg of the resulting solution (0.21 mmol (calculated on pentaerythritol tetrakis(2-mercaptoacetate) repeating unit) was added 13 mg of dibutyl tin dilaurate (0.02 mmol) and 211 mg of hexamethylene diisocyanate (1.26 mmol). The mixture was heated to 100° C. for 10 s to obtain a homogeneous solution. The mixture was then stirred at room temperature until gel formation and subsequently cured at 50° C. for 24 hours. A colorless solid was formed.

DSC: Tg=35° C.

### Elemental Analysis:

| | | | | |
|---|---|---|---|---|
| calculated [%]: | C: 44.65 | H: 5.84 | N: 7.37 | S: 16.88 |
| found [%]: | C: 45.33 | H: 6.05 | N: 7.64 | S: 16.74 |

### Example 2: Degradation with ethylene glycol bis(2-mercaptoacetate) and ethylene glycol, and Repolymerization

225 mg Polythiourethane network (pentaerythritol tetrakis(2-mercaptoacetate)/hexamethylene diisocyanate; ratio 1/2; 0.29 mmol (calculated on pentaerythritol tetrakis(2-mercaptoacetate) repeating unit)) were added to ethylene glycol bis(2-mercaptoacetate) (308 mg; 1.46 mmol) and ethylene glycol (91 mg; 1.46 mmol) in a microwave vial. The vessel was hermetically sealed and the mixture was stirred at 150° C. for 3 hours.

To the resulting solution was added 12 mg dibutyltin dilaurate (0.02 mmol) and 493 mg hexamethylene diisocyanate (2.93 mmol). The mixture was heated to 100° C. for 10 s to obtain a homogeneous solution. The mixture was then stirred at room temperature until gel formation and subsequently cured at 60° C. for 24 hours. A colorless solid was formed.

### Elemental Analysis:

calculated [%]: C: 46.94 H: 6.45 N: 8.82 S: 11.77
found [%]: C: 47.46 H: 6.50 N: 9.08 S: 11.53

1. A process for recycling polythiourethane comprising the following steps:
a) providing a mixture of polythiourethane and di- or higher-functional thiol and a di- or higher-functional polar protic reactive solvent, wherein at least one mole of di- or higher-functional thiol is used per mole of thiourethane bond of the polythiourethane,
b) depolymerizing the polythiourethane by treating the mixture from step a) at a first reaction temperature, thereby forming di- or higher-functional thiols from the polythiourethane and monomeric and oligomeric thiourethanes terminated with di- or higher-functional thiol,
c) separating impurities from the mixture obtained in step b),
d) adding di- or higher-functional isocyanate or epoxide or ethylenically unsaturated compound and di- or higher-functional thiol to the mixture from step b) or c),
e) treating the mixture from step d) at a second reaction temperature which is lower than, equal to or higher than the first reaction temperature, whereby the temperature is sufficient to enable polymerization of the monomeric and oligomeric thiourethanes from step b), the compounds added in step d) and the reactive solvent present takes place, with the proviso that the depolymerization in step b) and the polymerization in step e) occur in substance or in the presence of a di- or higher-functional polar protic reactive solvent.

2. The process according to claim 1, comprising the depolymerization in step b) and the polymerization in step e) occur in substance.

3. The process according to claim 1 comprising, the depolymerization in step b) and the polymerization in step e) occur in the presence of a catalyst.

4. The process according to claim 3, wherein the catalyst is selected from the group consisting of tertiary amine, 1,8-diazabicyclo[5.4.0]undec-7-ene (DBU), phosphine or organic tin compounds.

5. The process according to claim 1, wherein the first reaction temperature and the second reaction temperature are in the range between 20° C. and 220° C.

6. The process according to claim 1, wherein 1.5 to 100 moles of the di- or higher-functional thiol are used in step a) per mole of thiourethane bond of the polythiourethane.

7. The process according to at least one of claim 1, wherein the oligomeric polythiourethanes from step b) have two to sixteen repeating units.

8. The process according to claim 1, wherein the thiol used in step a) is a di-, tri- or tetra-functional thiol selected from the group consisting of hexanedithiol, dodecanedithiol, limonene dithiol, myrcentrithiol, fern tetrathiol, pentaerythritol tetra-(3-mercaptopropionate), trimethylolpropane tri-(3-mercaptopropionate), tris-[2-(3-mercaptopropionyl-oxy)ethyl]-isocyanurate, ethylene glycol-di-(3-mercapto-propionate), diethylene glycol ether-di-(3-mercaptopropionate), dipentaerythrithexa-(3-mercapto-propionate), ethoxylated trimethylolpropane-tri-(3-mercaptopropionate), propoxylated trimethylolpropane-tri-(3-mercaptopropionate), polycaprolactone-tetra-(3-mercaptopropionate) or mixtures of two or more thereof.

9. The process according to claim 1, wherein a di- or higher-functional isocyanate is used in step d).

10. The process according to claim 9, wherein the isocyanate used in step d) is selected from the group consisting of 4,4′-diphenylmethane diisocyanate, 1,4-phenylene diisocyanate, 1,4-xylylene diisocyanate, toluene-2,4-diisocyanate, toluene-2,6-diisocyanate, 2,4′-diphenylmethane diisocyanate, 2,2′-diphenylmethane diisocyanate, hexane-1,6-diisocyanate or trimeres thereof, isophorone diisocyanate, norbornane diisocyanate, pentamethylene diisocyanate, tetramethylxylylene diisocyanate, 4,4′-dicyclohexylmethane diisocyanate, triisocyanatononane, cyclohexane-1,4-diisocyanate or mixtures of two or more thereof.

11. The process according to claim 1, characterized in that the polythiourethane used in step a) is a polythiourethane network.

12. The process according to claim 11, wherein the thiol obtained in step b) from the polythiourethane is a tri- or higher-functional thiol.

13. The process according to claim 1, wherein in step a) a polythiourethane is used which is a polythiourethane network composed of biobased monomers.

14. The process according to claim 1 wherein the di- or higher-functional thiol used in step a) is a biobased raw material and the di- or higher-functional isocyanate or epoxide or ethylenically unsaturated compound used in step d) are biobased raw materials.

15. Compositions containing monomers of the formula (XIX) and oligomers of the formula (XXI) or containing monomers of the formula (XX) and oligomers containing structural units of the formula (XXII) 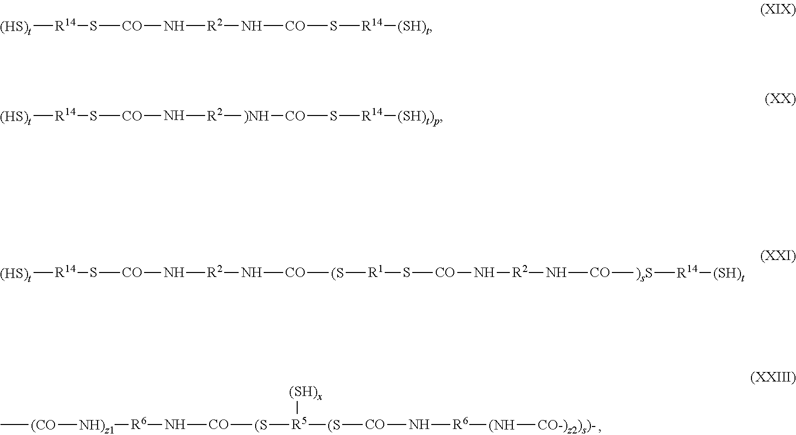
wherein R¹ and R² independently of one another are divalent organic radicals,
R⁵ is an (x+z2+1)-valent organic radical,
R⁶ is a (z1+1)-valent or a (z2+1)-valent organic radical,
R¹⁴ is a (t+1)-valued organic radical,
t is an integer greater than or equal to 1,
p is 2 to 10, preferably 2 or 3,
s is an integer from 1 to 15,
x is an integer from 0 to 9,
z1 and z2 independently of one another are integers from 1 to 10,
the sum x+z2 is an integer from 1 to 10
that
the oligomer of the formula (XXII) has further radicals of the formula (XVIII) which are linked to the oligomer via thioisocyanate groups 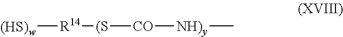
wherein w is an integer greater than or equal to 1,
R¹⁴ and t have the meanings defined above,
w is less than t, and
y is an integer with the value t+1−w, that
the proportion of monomers of the formula (XIX) and of oligomers of the formula (XXI) in the composition may be from 0 to 100 mol %, based on the total amount of these compounds, the sum of these compounds always being 100 mol %, and that
the proportion of the monomers of the formula (XX) and of the oligomers containing the structural units of the formula (XXII) in the composition may be from 0 to 100 mol %, based on the total amount of these compounds, the sum of these compounds always being 100 mol %.

16. The compositions according to claim 15, wherein R¹ and R² independently of one another are alkylene, cycloalkylene, arylene, aralkylene or heterocyclylene, R⁵ is an (x+z2+1)-valent alkyl, cycloalkyl, aryl, aralkyl or heterocyclyl radical, R⁶ is a (z1+1)-valent or a (z2+1)-valent alkyl, cycloalkyl, aryl, aralkyl or heterocyclyl radical, R¹⁴ is a (t+1)-valent alkyl, cycloalkyl, aryl, aralkyl or heterocyclyl radical, x+z2 is independently 1, 2 or 3, and t is an integer from 1 to 9 and in particular from 1 to 3.

17. The compositions according to claim 15, wherein the monomers and oligomers obtained by the depolymerization of a polythiourethane network derived from 4,4-methylene-bis-(cyclohexylisocyanate) and ethoxylated trimethylolpropane-tris-(3-mercaptopropionate) are excluded.

18. The compositions according to claim 15, wherein R¹ is cycloalkylene, arylene, aralkylene or heterocyclylene, and R⁵ is an (x+z2+1)-valent cycloalkyl, aryl, aralkyl or heterocyclyl radical.

19. A process to use of the compositions according to claim 15 selected from the process for the preparation of polythiourethanes, for the preparation of copolymers containing polythiourethane groups, as curing agents of epoxy compounds, or as curing agents of compounds containing ethylenically unsaturated groups.

20. The process of claim 1 in the absence of di- or higher-functional thiol to the mixture from step d).

21. The process of step 1 in the absence of step c).

22. The process of claim 1 wherein solvent is absent from steps a) and e) and further the process is conducted in the absence of di- or higher-functional thiol to the mixture from step d).

23. The process of claim 1 wherein solvent is absent from steps a) and e) and further the process is conducted in the absence of step c).

24. The process of claim 1 wherein the solvent is absent in steps a) and e), and further the process is conducted in the absence of step c), and still further, step d) is conducted in the absence of di- or higher-functional thiol to the mixture from step b).
